(19) United States
(12) Patent Application Publication
(10) Pub. No.: US 2014/0351089 A1
(43) Pub. Date: Nov. 27, 2014

(54) RECORDING MEDIUM, INFORMATION PROCESSING APPARATUS, PRODUCT SELLING SYSTEM AND PRODUCT SELLING METHOD

(71) Applicant: NINTENDO CO., LTD., Kyoto (JP)

(72) Inventors: Kouichi KAWAMOTO, Kyoto (JP); Ryusuke NIITANI, Kyoto (JP)

(73) Assignee: NINTENDO CO., LTD., Kyoto (JP)

(21) Appl. No.: 14/257,463

(22) Filed: Apr. 21, 2014

(30) Foreign Application Priority Data
May 27, 2013 (JP) 2013-111185

(51) Int. Cl. G06Q 30/06

(52) U.S. Cl. CPC G06Q 30/0601
USPC 705/26.61; 705/26.1

(57) ABSTRACT

An example system includes an information processing apparatus having a communication part for making communication via a network; a selling processing part for performing a process for selling product; a restart judging part for judging whether, after a process using the communication part and being included in the process performed by the selling processing part is interrupted, the interrupted process can be restarted or not; and a restarting part for restarting the process performed by the selling processing part from a predetermined point in the processing stage of the process in the case that the restart judging part judged that the process can be restarted, and a server apparatus having a communication part for making communication with the information processing apparatus via a network and a selling processing part for performing a process for selling product between the information processing apparatus and the server apparatus by using communication via the communication part.

### CROSS-REFERENCE TO RELATED APPLICATIONS

This application is based upon and claims the benefit of priority of the prior Japanese Patent Application No. 2013-111185, filed on May 27, 2013, the entire contents of which are incorporated herein by reference.

### FIELD

The technology herein relates to a recording medium on which an information processing program for executing a product selling/purchasing process via a network is recorded and to an information processing apparatus, a product selling system and a product selling method.

### BACKGROUND AND SUMMARY

Conventionally, a product selling system for realizing product selling/purchasing by performing communication between the information processing apparatus of a user and the server apparatus operated by a product selling store or the like has been used widely. This application describes a product selling system in which a request for purchasing the product selected by the user is given to the server apparatus by the information processing apparatus, and for example, a settlement process is performed between the information processing apparatus and the server apparatus.

According to an aspect of the embodiment, a recording medium on which an information processing program is recorded makes an information processing apparatus equipped with a communication part for performing communication via a network to operate as a selling processing part for performing a process for selling product; as a restart judging part for judging whether, after a process using the communication part and being included in the process performed by the selling processing part is interrupted, the interrupted process can be restarted or not; and as a restarting part for restarting the process performed by the selling processing part from a predetermined point in the processing stage of the process in the case that the restart judging part judged that the process can be restarted.

The object and advantages of the embodiment will be realized and attained by means of the elements and combinations particularly pointed out in the claims. It is to be understood that both the foregoing general description and the following detailed description are exemplary and explanatory and are not restrictive of the embodiment.

These and other objects, characteristics, aspects and advantages of the technology will become more apparent from the following detailed description by referring to the accompanying drawings.

### BRIEF DESCRIPTION OF THE DRAWINGS

FIG. 1 shows an example non-limiting schematic view illustrating the outline of the process performed by an example non-limiting product selling system according to the embodiment;

FIG. 2 shows an example non-limiting schematic view illustrating the outline of the process performed by the product selling system according to the embodiment;

FIG. 3 shows an example non-limiting block diagram showing a configuration of an example non-limiting game machine according to the embodiment;

FIG. 4 shows an example non-limiting block diagram showing a configuration of an example non-limiting server apparatus according to the embodiment;

FIG. 5 shows an example non-limiting schematic view showing an example non-limiting interruption notification screen;

FIG. 6 shows an example non-limiting schematic view showing an example non-limiting selection accepting screen;

FIG. 7 shows an example non-limiting flow chart showing the steps of the process performed by the game machine;

FIG. 8 shows an example non-limiting flow chart showing the steps of the process performed by the game machine;

FIG. 9 shows an example non-limiting flow chart showing the steps of the process performed by the game machine;

FIG. 10 shows an example non-limiting flow chart showing the steps of the process performed by the server apparatus;

FIG. 11 shows an example non-limiting flow chart showing the steps of the process performed by an example non-limiting electronic book reader according to Embodiment 2;

FIG. 12 shows an example non-limiting flow chart showing the steps of the process performed by the electronic book reader according to Embodiment 2; and

FIG. 13 shows an example non-limiting flow chart showing the steps of the process performed by the electronic book reader according to Embodiment 2.

### DETAILED DESCRIPTION OF NON-LIMITING EMBODIMENTS

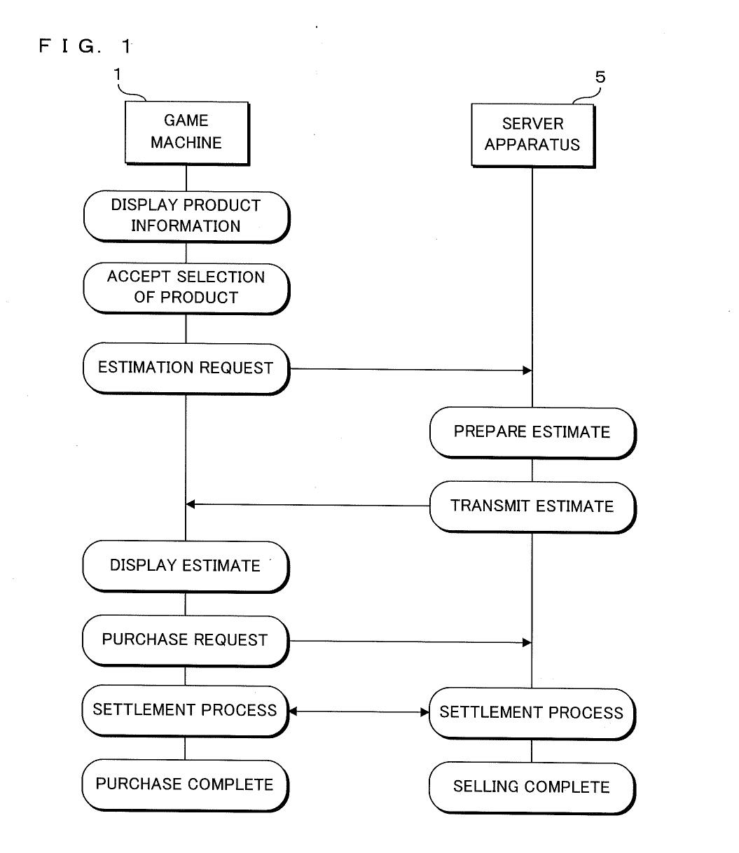

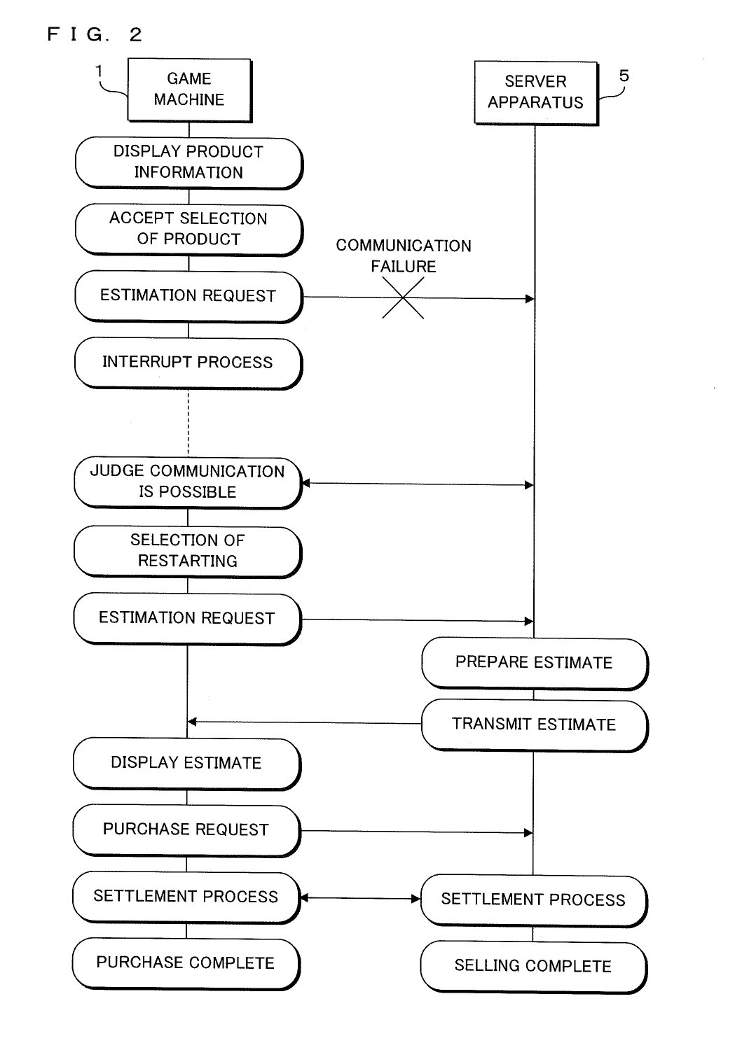

FIGS. 1 and 2 are schematic views illustrating the outline of the process performed by a product selling system according to this embodiment. In the product selling system according to the embodiment, an information processing apparatus used by a user, such as a game machine 1, communicates with a server apparatus 5 operated by a product selling store or the like. FIG. 1 shows an example of a flow in which the processes of the game machine 1 and the server apparatus 5 are performed normally without being interrupted. For example, the user can display product information, such as the list of products to be sold and the detailed information of the restrictive products, on the display part of the game machine 1 and can select a product to be purchased. In the embodiment, it is assumed that the product information to be displayed on the display part has been stored in the game machine 1. However, the game machine 1 may be configured so as to obtain the product information from the server apparatus 5. The game machine 1 accepts the selection of the product to be purchased depending on the operation of the user performed on the operation part thereof.

The game machine 1 having accepted the selection of the product transmits an estimation request to the server apparatus 5 to obtain the price information of the selected product. The server apparatus 5 having received the estimation request checks the price of the selected product, prepares an estimate and transmits the prepared estimate to the game machine 1. The game machine 1 having received the estimate displays the price information quoted in the estimate of the selected product. On the basis of the displayed price, the user can make the final decision as to whether the user purchases the selected product. In the case that the user performed the operation for purchasing the product, the game machine 1 transmits a request for purchasing the product to the server apparatus 5. The server apparatus 5 having received the purchase request starts a settlement process between the server apparatus and the game machine 1. In the settlement process, for example, information, such as a credit card number and a password, is transmitted and received between the game machine 1 and the server apparatus 5. In the case that the settlement process was completed, the purchase of the product at the game machine 1 is completed, and the selling of the product is completed at the server apparatus 5. In the case that the product is a digital content, the digital content is transmitted from the server apparatus 5 to the game machine 1 thereafter. Furthermore, in the case that the product is not a digital content, the store or the like operating the server apparatus 5 sends the product, for example.

FIG. 2 is a view showing an example of a flow in the case that the process performed between the game machine 1 and the server apparatus 5 was interrupted. For example, in the case that the communication between the game machine 1 and the server apparatus 5 was unable to be established when a product estimation request is transmitted from the game machine 1 to the server apparatus 5, the process for purchasing the product by the game machine 1 is interrupted. The game machine 1 displays, for example, an error message indicating that the communication was not able to be made and interrupts the process. At this time, the game machine 1 stores information relating to the interrupted process in its storage part. The information relating to the interrupted process is, for example, information on the product selected as an item to be purchased, information on up to which stage of the procedure required for the purchase proceeded, and information having been input for the purchase. After the interruption of the process, the user may perform other processes, such as browsing the information of other products or playing games, using the game machine 1, or may stop using the game machine 1 and turn off its power source. In this example, it is assumed that the user turned off the power source of the game machine 1.

Then, for example, in the case that the user turned on the power source of the game machine 1 or turned on the power source and started the program for purchasing products, the game machine 1 judges whether communication with the server apparatus 5 is possible. At this time, the game machine 1 performs, for example, predetermined information transmission/reception between the game machine 1 and the server apparatus 5 and can judge whether the communication is possible depending on whether the transmission/reception succeeded. In the case that it was judged that the communication with the server apparatus 5 is possible, the game machine 1 displays a message indicating that the interrupted process relating to the purchase of the product can be restarted on the display part. The game machine 1 accepts the selection as to whether the interrupted process is restarted.

In the case that the game machine 1 accepted the selection of not restarting the interrupted process, the game machine 1 does not restart the interrupted process. At this time, the game machine 1 may abort the information relating to the interrupted process and stored in the storage part. Instead of aborting the information stored in the storage part, the game machine 1 may accept again the selection as to whether the interrupted process is restarted at a predetermined time thereafter. Alternatively, a configuration may also be used in which the user can determine as to whether the information stored in the storage part is aborted, that is, as to whether the selection as to whether the interrupted process is restarted later.

In the case that the game machine 1 accepted the selection of restarting the interrupted process, the game machine 1 reads the information relating to the interrupted process from the storage part and restarts the interrupted process. In this example, since the process is interrupted at the stage of transmitting the estimation request from the game machine 1 to the server apparatus 5, the game machine 1 restarts the process from this stage. The game machine 1 transmits the estimation request for the product selected before the interruption of the process to the server apparatus 5. The subsequent process is similar to that described referring to FIG. 1.

The game machine 1 may be configured so that in the case that the process was interrupted, for example, at the stage of transmitting the purchase request or at the stage of the settlement process, the game machine starts the process from the interrupted stage. However, for example, in the case that the price of the product may change depending on the timing of the estimation, the game machine 1 may be configured so as to restart the process from the stage of transmitting the estimation request even in the case that the process was interrupted at the stage of transmitting the purchase request or at the stage of the settlement process. The restart of the process using the game machine 1 may be performed from the stage in which the process was interrupted or from a predetermined stage earlier than the stage.

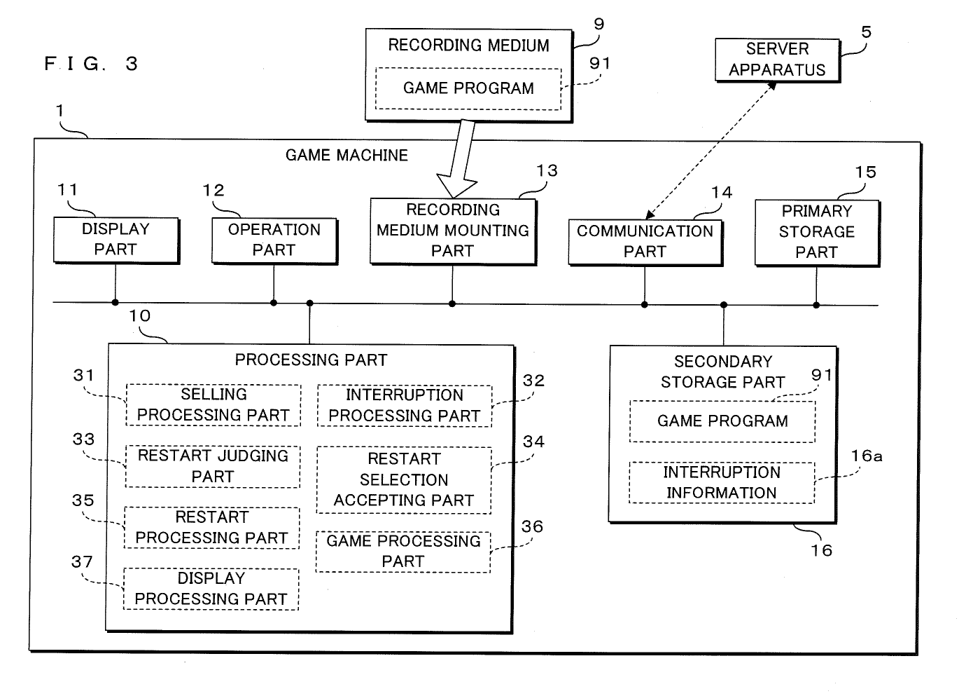

FIG. 3 is a block diagram showing a configuration of the game machine 1 according to the embodiment. The game machine 1 according to the embodiment is a portable type that can be carried by the user. The game machine 1 is equipped with a processing part (processor) 10, a display part 11, an operation part 12, a recording medium mounting part 13, a communication part (communication circuit) 14, a primary storage part 15, and a secondary storage part 16, etc.

The processing part 10 of the game machine 1 is composed of an arithmetic processor, such as a CPU (central processing unit). The processing part 10 reads a game program 91 stored in the secondary storage part 16 or the game program 91 stored in a recording medium 9 mounted on the recording medium mounting part 13 onto the primary storage part 15 and executes the game program. The processing part 10 thus performs various information processes relating to a game. For example, the processing part 10 performs a process of accepting the operation performed on the operation part 12. For example, the processing part 10 makes a judgment with respect to the game depending on the accepted operation. For example, the processing part 10 performs a process of generating a game image that is displayed on the display part 11 depending on, for example, the accepted operation or an event in the game.

The display part 11 is composed using a liquid crystal panel or the like and displays images given by the processing part 10. The operation part 12 is composed of, for example, push-down type buttons or a touch panel provided on the display part 11. The operation part 12 notifies the content of the operation performed by the user to the processing part 10. The content of the operation to be notified is, for example, button pressing or releasing operation. The recording medium mounting part 13 is configured so that the recording medium 9, such as a card-type medium, can be mounted and dismounted. The processing part 10 can read the game program 91 and other various kinds of data from the recording medium 9 mounted on the recording medium mounting part 13.

The communication part 14 performs connection to a network, such as the Internet, using a wireless LAN (local area network). The communication part 14 transmits and receives data to and from, for example, the server apparatus 5 or another game machine 1 via the network. For example, the game machine 1 can perform various processes relating to product selling by performing communication with the server apparatus 5 using the communication part 14. The primary storage part 15 is configured using a semiconductor memory device or the like. Various kinds of data generated in association with the arithmetic processing of the processing part 10 are temporarily stored in the primary storage part 15. The secondary storage part 16 is configured using a nonvolatile storage device having a capacity larger than that of the primary storage part 15. The secondary storage part 16 can store programs, such as the game program 91, and various kinds of data including interruption information 16a.

In the game machine 1 according to the embodiment, the processing part 10 executes the game program 91, whereby, for example, a selling processing part 31, an interruption processing part 32, a restart judging part 33, a restart selection accepting part 34, a restart processing part 35, a game processing part 36 and a display processing part 37 are realized as software-like function blocks in the processing part 10. The selling processing part 31 performs a process relating to product selling by using the communication with the server apparatus 5 as described above.

The selling processing part 31 performs a process of reading product information, such as the list of purchasable products and the detailed information of the respective products, from the secondary storage part 16 and presenting the product information to the user. The selling processing part 31 performs, for example, a process of accepting the selection of a product to be purchased. The selling processing part 31 performs a process of, for example, transmitting the estimation request and the purchase request for a product to the server apparatus 5. The selling processing part 31 performs, for example, a settlement process with the server apparatus 5. The interruption processing part 32 detects whether an interruption factor, such as the disruption of communication with the server apparatus 5 via the communication part 14, occurred, and performs a process of detecting whether the process of the selling processing part 31 was interrupted. In the case that the process of the selling processing part 31 was interrupted, the interruption processing part 32 stores information relating to the interrupted process in the secondary storage part 16 as the interruption information 16a. The interruption information 16a includes, for example, information on the product selected as an item to be purchased, information on up to which stage of the procedure required for the purchase proceeded, and information having been input for the purchase.

After the process of the selling processing part 31 was interrupted, the restart judging part 33 judges, for example, whether the communication part 14 can communicates with the server apparatus 5 at a predetermined timing. The restart judging part 33 thus judges whether the interrupted process can be restarted. The judgment by the restart judging part 33 may be made, for example, at the start time of the game machine 1 or the processing start time of the game program 91, or may be made periodically at predetermined intervals, for example, every several minutes or every several hours after the occurrence of the interruption. In the case that the restart judging part 33 judged that the restart is possible, the restart selection accepting part 34 notifies that the interrupted process can be restarted to the user. The restart selection accepting part 34 performs a process of accepting the selection as to whether the interrupted process is restarted at the operation part 12. In the case that the restart selection accepting part 34 accepted the selection of the restart of the process, the restart processing part 35 performs a process of restarting the interrupted process of the selling processing part 31 on the basis of the interruption information 16a stored in the secondary storage part 16. The restart processing part 35 may restart the process from, for example, the time point when the process of the selling processing part 31 was interrupted. The restart processing part 35 may also restart the process from a predetermined time point, for example, at the stage in which the estimation request is transmitted to the server apparatus 5.

The game processing part 36 performs, for example, various judgment processes or event processes relating to games depending on, for example, the user operation accepted at the operation part 12. The display processing part 37 generates a game screen depending on the processing result of the game processing part 36 and gives the game screen to the display part 11. Hence, the display processing part 37 performs a process of displaying the game screen on the display part 11. The display processing part 37 performs a process of displaying images required for the process relating to product selling and performed by the selling processing part 31, such as the list of purchasable products and the detailed information of the respective products, on the display part 11. The display processing part 37 performs a process of generating and displaying a selection accepting screen that is used when the restart selection accepting part 34 accepts a selection.

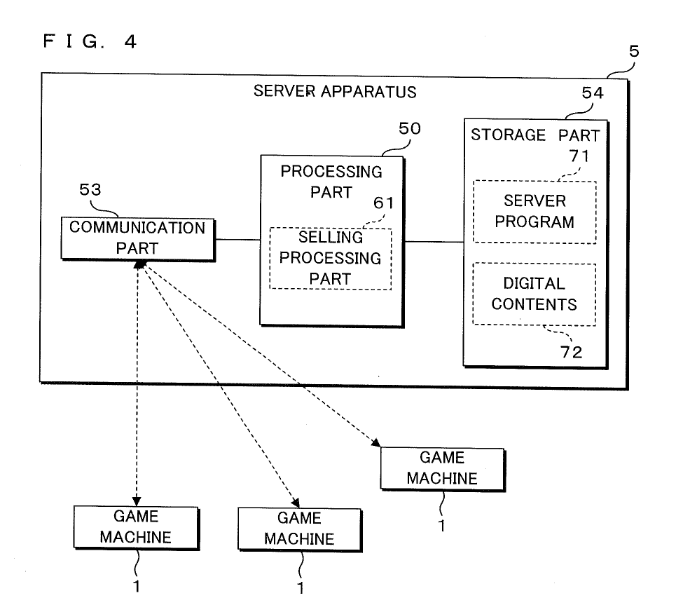

FIG. 4 is a block diagram showing a configuration of the server apparatus 5 according to the embodiment. The server apparatus 5 according to the embodiment performs a product selling process for selling digital contents to the user who uses the game machine 1. The server apparatus 5 is equipped with, for example, a processing part (processor) 50, a communication part (communication circuit) 53 and a storage part 54. The processing part 50 executes a server program 71 stored in the storage part 54, thereby performing various processes relating to product selling. By the execution of the server program 71, for example, a selling processing part 61 is realized as a software-like function block in the processing part 50. The selling processing part 61 performs, for example, a process of preparing an estimate depending on an estimation request from the game machine 1 and transmitting the estimate and a settlement process depending on a purchase request from the game machine 1.

The communication part 53 performs data transmission/reception to and from one or more game machines 1 via a network, such as the Internet. The storage part 54 stores, for example, the server program 71 that is executed by the processing part 50 and digital contents 72 provided as products to be sold. The server apparatus 5 may obtain, for example, the server program 71 and the digital contents 72 via the network and store them in the storage part 54. The server apparatus 5 may read, for example, the server program 71 and the digital contents 72 recorded on the recording medium mounted on a recording medium mounting part (not shown) and store them in the storage part 54.

In the product selling system according to the embodiment, the server apparatus 5 sells digital contents, such as items used in games executed by the game machine 1, additional scenarios or additional stages of games, or mini games that can be played inside the games. In the game machine 1, the processing part 10 executes the game program 91, whereby games, such as role-playing games or action games, in which, for example, the character operated by the user moves or attacks in a three-dimensional virtual space, are realized. The user can play the games according to the embodiment in the so-called off-line state in which the game machine 1 basically does not make communication with the server apparatus 5. The process relating to the games is performed by the game processing part 36 of the processing part 10.

In the games according to the embodiment, a virtual store is provided inside a virtual space. The user can operate a character so that the character enters the virtual store. Hence, the user can display a digital content purchase screen on the display part 11 of the game machine 1 and can purchase a digital content. The process relating to the purchase of digital contents is performed by the selling processing part 31 of the processing part 10. In other words, in the game machine 1, in the case that the condition that the character enters the virtual store has been satisfied, a game mode in which an ordinary game process using the game processing part 36 is performed is shifted to a product selling mode in which a digital content selling process using the selling processing part 31 is performed.

In the product selling mode, the selling processing part 31 of the game machine 1 displays the list of purchasable digital contents on the display part 11. The user operates the operation part 12, thereby select a digital content from the displayed list. The user can thus display the detailed information of the selected digital content on the game machine 1. In the embodiment, the list of purchasable digital contents and the detailed information of the respective digital contents have been stored together with the game program 91 in the secondary storage part 16 or the recording medium 9. The selling processing part 31 of the game machine 1 reads the information stored in the secondary storage part 16 or the recording medium 9 and gives the information to the display processing part 37, whereby, for example, the list of the digital contents or the detailed information thereof are displayed. Hence, the user can check and select a digital content to be purchased in the off-line state of the game machine 1.

However, in the embodiment, the prices of the respective digital contents are not displayed at the time when the list of the digital contents is displayed or the detailed information thereof is displayed. The prices of the respective digital contents are managed by the server apparatus 5. The selling processing part 31 of the game machine 1 is required to obtain the price information of the digital contents from the server apparatus 5 and to display the prices. For example, in the state in which a digital content is selected and the detailed information of this digital content is displayed on the display part 11 and in the case that, for example, the operation for purchasing the digital content or the operation for checking its price was accepted at the operation part 12, the selling processing part 31 transmits the estimation request for the digital content to the server apparatus 5 via the communication part 14.

In the case that the server apparatus 5 received the estimation request from the game machine 1 via the communication part 53, the selling processing part 61 of the processing part 50 performs a process of preparing an estimate of the digital content relating to the estimation request. The price information of the respective digital contents may be stored in the storage part 54 of the server apparatus 5 or may be obtained from another apparatus by communication via the communication part 53. The selling processing part 61 of the server apparatus 5 transmits the price information of the digital content as its estimate to the game machine 1.

Upon receiving the estimate from the server apparatus 5, the selling processing part 31 of the game machine 1 displays the price of the digital content in correspondence with the received estimate. Then, in the case that the selling processing part 31 accepted the operation for approving the purchase of the digital content at the displayed price through the operation part 12, the selling processing part 31 transmits the purchase request for the digital content to the server apparatus 5. Upon receiving the purchase request, the selling processing part 61 of the server apparatus 5 starts a settlement process with the game machine 1. In the settlement process, information transmission/reception is performed one or more times between the game machine 1 and the server apparatus 5. The information to be transmitted and received at this time can include, for example, authentication information, such as the ID (identifier) and the password of the user, or, for example, the credit card number that is used for payment.

In the case that the settlement process was completed, the selling processing part 31 of the game machine 1 gives a request for transmitting the purchased digital content to the server apparatus 5. In response to the transmission request, the selling processing part 61 of the server apparatus 5 reads the purchased digital content from the digital contents 72 stored in the storage part 54 and transmits the digital content to the game machine 1. The selling processing part 31 of the game machine 1 receives the digital content transmitted from the server apparatus 5 and stores the digital content in the storage part 16. In the case that the operation for ending the purchase of the digital content was performed, the game machine 1 shifts its mode from the product selling mode to the game mode. This operation corresponds to, for example, the operation for leaving the virtual store in the game. With this operation, the user can restart the play of the game using the game program 91 on the game machine 1. In the case that the digital content was purchased, the purchased digital content is reflected in the game played after the restart.

The game machine 1 according to the embodiment is a portable type. The communication part 14 of the game machine 1 communicates with the server apparatus 5 by wireless communication using, for example, a portable telephone network or a wireless LAN. Hence, the game machine 1 cannot communicate with the server apparatus 5 in some cases, for example, in the case that the game machine 1 is located at the outside of an electromagnetic wave arrival range and cannot use the wireless communication. With the game machine 1 according to the embodiment, even in a state in which the wireless communication is impossible, a game using the game program 91 can be played, and the list of digital contents and the detailed information thereof, for example, can be displayed in the product selling mode. However, the game machine 1 requires communication with the server apparatus 5 to perform, for example, the estimation request, the purchase request, the settlement process and the downloading for the digital content. Therefore, in the case that the game machine 1 was in the state of incapable of performing communication via the communication part 14, the process performed by the selling processing part 31 may be interrupted.

The interruption processing part 32 of the game machine 1 detects the interruption of the process performed by the selling processing part 31. For example, in the case that no response is obtained for a predetermined time in a situation in which a response from the server apparatus 5 is expected, the interruption processing part 32 judges that a problem occurred in communication and judges that the process performed by the selling processing part 31 was interrupted. The situation in which a response is expected may occur when, for example, the estimation request transmission process, the purchase request transmission process or the settlement process is performed by the selling processing part 31. In the case that the interruption of the process occurred, the interruption processing part 32 stores information relating to the interrupted process in the secondary storage part 16 as the interruption information 16a.

The interruption information 16a may include information on at which stage the process of the selling processing part 31 was interrupted. In the embodiment, the digital content purchasing process performed by the selling processing part 31 is divided into three stages: an estimation stage in which an estimation request is transmitted, a settlement stage in which a purchase request is transmitted or a settlement process is performed, and a downloading stage in which a purchased digital content is obtained from the server apparatus 5. As the interruption information 16a, information on at which stage the interruption occurred is stored. The interruption information 16a may include information relating to the digital content to be estimated or purchased at the time of the interruption. Other information may also be included in the interruption information 16a.

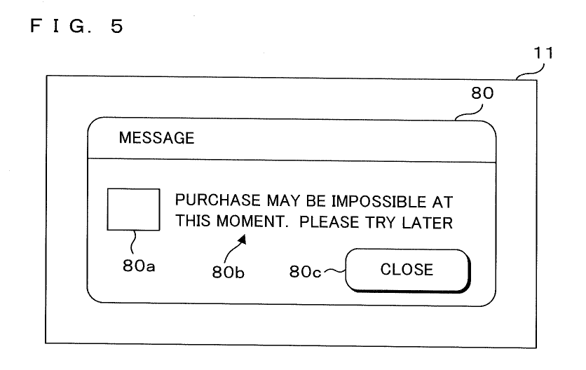

In the case that the process of the selling processing part 31 was interrupted, the interruption processing part 32 gives an instruction for displaying an interruption notification screen on the display part 11 to the display processing part 37 to notify that the process was interrupted to the user. FIG. 5 is a schematic view showing an example of the interruption notification screen. In the example shown in the figure, for example, a window or a dialog is displayed on the display part 11 of the game machine 1 as an interruption notification screen 80 to give a message. This interruption notification screen 80 is provided with an icon 80a indicating the digital content to be estimated or purchased, a message 80b notifying the interruption of the process to the user, and a “CLOSE” button 80c for closing (not showing) the interruption notification screen 80. As the message 80b, for example, an expression stating that “Purchase may be impossible at this moment. Please try later” can be used. Since the interruption processing part 32 displays the interruption notification screen 80 on the display part 11, the user can know that the digital content purchasing process was interrupted. In the case of the interruption notification screen 80 shown in the figure, no interruption factor is indicated on the interruption notification screen 80. However, for example, a message notifying a failure factor of the communication with the server apparatus 5 to the user may be displayed on the interruption notification screen 80.

After the interruption notification screen 80 was displayed on the display part 11 and the interruption notification screen 80 was closed by the operation of the user, the game machine 1 according to the embodiment can perform a process not requiring communication with the server apparatus 5. In other words, even in the case that the digital content purchasing process was interrupted, the user can display the list of digital contents or the detailed information thereof. Furthermore, the user can leave the virtual store and play a game.

In the game machine 1 according to the embodiment, after the process was interrupted as described above, the restart judging part 33 of the processing part 10 judges whether the interrupted process can be restarted at a predetermined timing. For example, in the case that a message was transmitted to the server apparatus 5 at a predetermined timing and a response to the message was received, the restart judging part 33 can judge that the communication with the server apparatus 5 is possible and that the interrupted process can be restarted. For example, the following can be adopted as the timing of the restart judgment to be made by the restart judging part 33.

In the case that the game program 91 was started in the game machine 1
In the case that the power ON state of the game machine 1 was restored from the power OFF state or the suspended state thereof, for example
In the case that reentry into the virtual store was performed during game playing
Periodically, for example, every 10 minutes or every hour

The restart judging part 33 does not require to adopt all the above-mentioned four judgment timings, but may adopt one or more judgment timings appropriately. Furthermore, the restart judging part 33 may adopt judgment timings other than those described above.

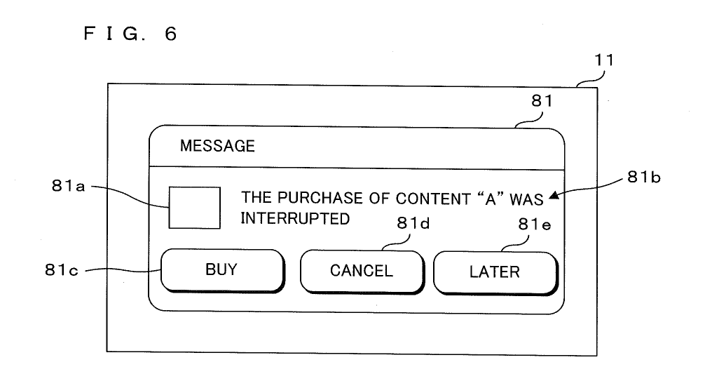

In the case that the restart judging part 33 judged that the restart is possible, the restart selection accepting part 34 of the processing part 10 performs a process of accepting the selection as to whether the interrupted process is restarted. The restart selection accepting part 34 gives an instruction for displaying the selection accepting screen on the display part 11 to the display processing part 37 to accept the selection. FIG. 6 is a schematic view showing an example of the selection accepting screen. In the example shown in the figure, for example, a window or a dialog provided with a plurality of buttons for selection is displayed as a selection accepting screen 81 on the display part 11 of the game machine 1. This selection accepting screen 81 is provided with an icon 81a indicating the digital content relating to the interrupted process, a message 81b notifying that process interruption occurred to the user, and buttons for accepting the selection: a “BUY” button 81c, a “CANCEL” button 81d and a “LATER” button 81e. For example, in the case that the purchase of digital content A was interrupted, an expression stating that “The purchase of content A was interrupted.” can be used as the message 81b. It is possible to judge which digital content relates to the interrupted process on the basis of the interruption information 16a stored in the secondary storage part 16.

In the case that the “CANCEL” button 81d was operated on the selection accepting screen 81, the processing part 10 does not restart the interrupted process. The processing part 10 deletes the interruption information 16a stored in the secondary storage part 16 and closes the selection accepting screen 81, and the game processing part 36 performs a game process, for example. In the case that the “LATER” button 81e was operated, the processing part 10 closes the selection accepting screen 81, and the game processing part 36 performs a game process, for example. In this case, the restart judgment by the restart judging part 33 is made continuously. In the case that it was judged that the restart is possible at a later timing of the judgment, the selection acceptance by the restart selection accepting part 34 is performed again.

In the case that the “BUY” button 81c was operated on the selection accepting screen 81, the restart processing part 35 of the processing part 10 restarts the interrupted process of the selling processing part on the basis of the interruption information 16a stored in the secondary storage part 16. As describe above, the interruption information 16a includes the information on at which stage: the estimation stage, the settlement stage or the downloading stage, the process interruption occurred. The interruption information 16a includes information on which digital content related to the interrupted process, that is, which digital content was attempted to be purchased by the user. The restart processing part 35 gives a process restart instruction to the selling processing part 31 to restart the digital content purchasing process from the processing stage stored in the interruption information 16a. However, in the embodiment, in the case that the process interruption stage is the settlement stage, the restart processing part 35 gives an instruction for restarting the interrupted process from the estimation stage. The reason for this is that the price of the digital content may have changed in the period from the process interruption to the restart. After giving the restart instruction to the selling processing part 31, the restart processing part 35 deletes the interruption information 16a from the secondary storage part 16.

In the case that the restart instruction was given from the restart processing part 35, the selling processing part 31 restarts the instructed digital content purchasing process from the instructed processing stage. The restart processing part 35 makes the display processing part 37 to display, for example, an image inside the virtual store on the display part 11. The restart processing part 35 makes communication with the server apparatus 5, which was impossible before. For example, in the case that the process is restarted from the estimation stage, the selling processing part 31 transmits the estimation request to the server apparatus 5. For example, in the case that the process is restarted from the downloading stage, the selling processing part 31 transmits the transmission request for the digital content to the server apparatus 5. As a result, the interrupted process of the selling processing part 31 is restarted. The user can thus restart the procedure for purchasing the digital content which was unable to be purchased before.

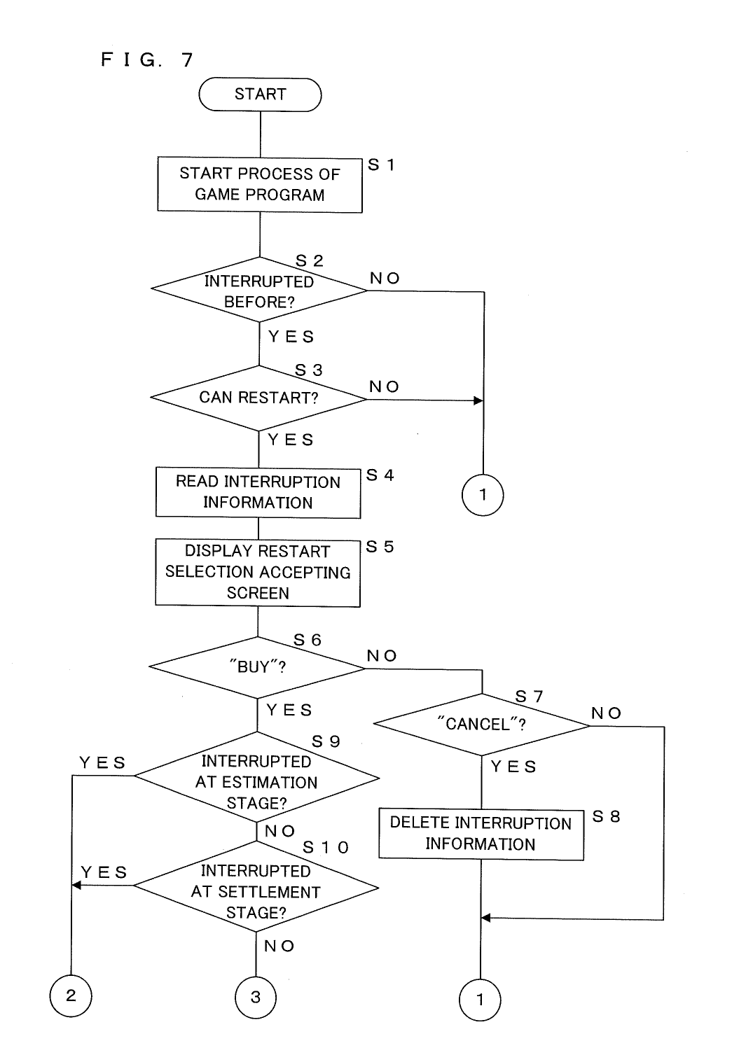

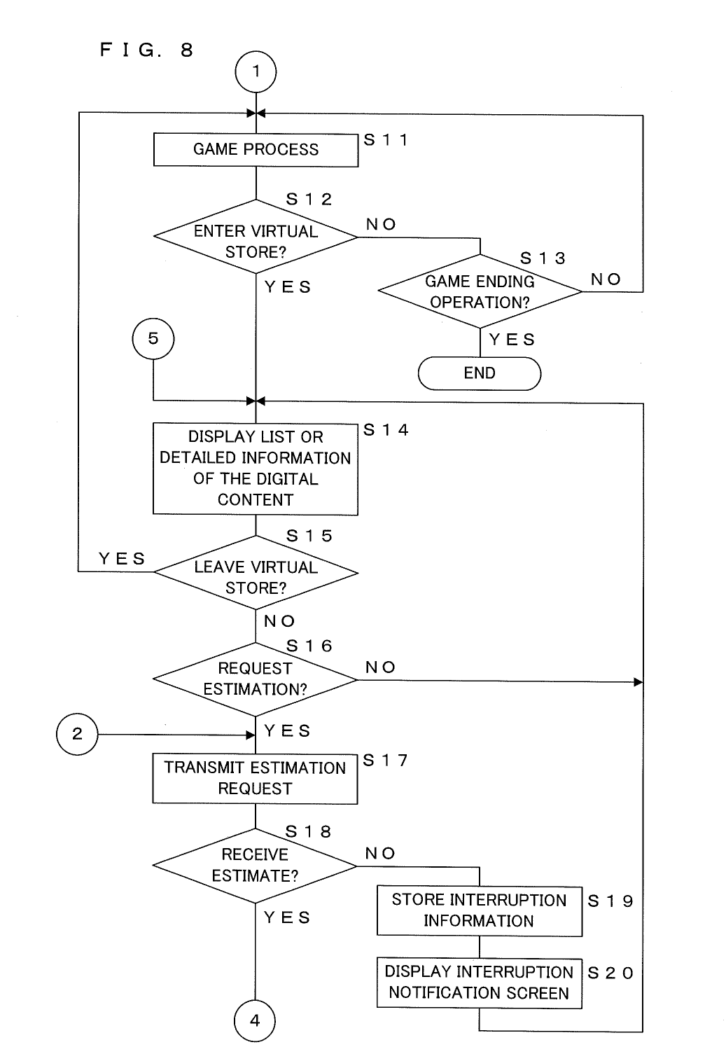

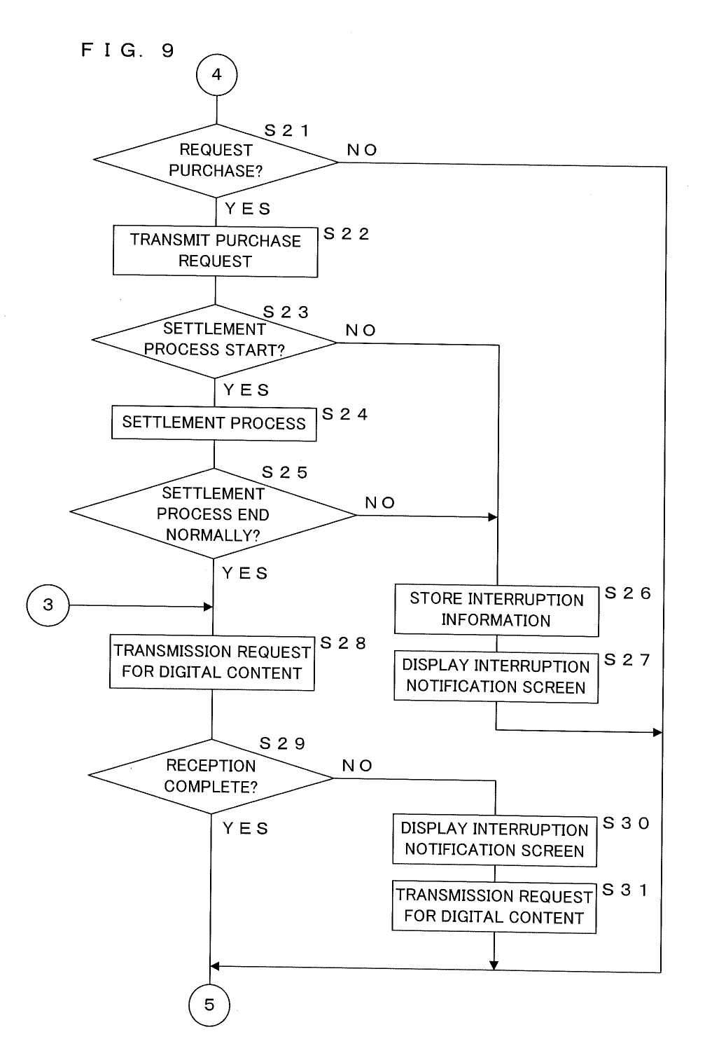

FIGS. 7 to 9 are flow charts showing the steps of the process performed by the game machine 1. In the flow charts, the restart judging part 33 is configured so as to make the restart judgment at the start time of the game program 91. The processing part 10 of the game machine 1 starts the process by reading the game program 91 stored in the secondary storage part 16 or the recording medium 9 and by executing the program (at step S1). At this time, the restart judging part 33 of the processing part 10 checks, for example, whether the interruption information 16a has been stored in the secondary storage part 16, thereby judging whether a digital content purchasing process was interrupted before (at step S2). In the case that it was judged that the purchasing process was interrupted (YES at S2), the restart judging part 33 tries to make communication with the server apparatus 5. The restart judging part 33 judges whether the purchasing process can be restarted depending on the presence/absence of a response from the server apparatus 5 (at step S3). In the case that the purchasing process is not interrupted (NO at S2) or the purchasing process cannot be restarted (NO at S3), the processing part 10 advances the process to step S11.

In the case that the restart judging part 33 judged that the purchasing process can be restarted (YES at S3), the processing part 10 reads the interruption information 16a stored in the secondary storage part 16 (at step S4). The restart selection accepting part 34 of the processing part 10 gives an instruction to the display processing part 37, whereby the restart selection accepting screen 81 is displayed on the display part 11 (at step S5). The restart selection accepting part 34 accepts the selection of “BUY”, “CANCEL” or “LATER” on the restart selection accepting screen 81. The restart selection accepting part 34 judges whether “BUY” was selected (at step S6). In the case that “BUY” is not selected (NO at step S6), the restart selection accepting part 34 judges whether “CANCEL” was selected (at step S7). In the case that “CANCEL” was selected (YES at S7), the processing part 10 deletes the interruption information 16a of the secondary storage part 16 (at step S8) and advances the process to step S11. In the case that “CANCEL” is not selected (NO at S7), that is, in the case that “LATER” was selected, the processing part 10 advances the process to step S11.

In the case that the restart selection accepting part 34 judged that “BUY” was selected on the restart selection accepting screen 81 (YES at S6), the restart processing part 35 of the processing part 10 judges to determine at which stage the previous purchasing process was interrupted on the basis of the interruption information 16a. The restart processing part 35 judges whether the purchasing process was interrupted at the estimation stage (at step S9). In the case that the purchasing process was not interrupted at the estimation stage (NO at step S9), the restart processing part 35 judges whether the purchasing process was interrupted at the settlement stage (at step S10). In the case that the purchasing process was interrupted at the estimation stage (YES at S9) or in the case that the purchasing process was interrupted at the settlement stage (YES at S10), the restart processing part 35 advances the process to step S17 and restarts the process from the transmission of the estimation request. In the case that the purchasing process is not interrupted at the settlement stage (NO at S10), that is, in the case that the purchasing process was interrupted at the downloading stage, the restart processing part 35 advances the process to step S28 and restarts the process from the transmission request for the digital content.

In the case that the previous purchasing process is not interrupted or, for example, in the case that the user does not desire to restart the interrupted process, the game processing part 36 of the processing part 10 performs a game process (at step S11). The game processing part 36 judges whether the character operated by the user entered the virtual store in the game (at step S12). In the case that the character is not in the virtual store (NO at S12), the game processing part 36 judges whether a game ending operation or the like was performed (at step S13). In the case that the game ending operation or the like was performed (YES at step S13), the processing part 10 ends the process performed by the game program 91. In the case that the game ending operation or the like is not performed (NO at S13), the game processing part 36 returns the process to step S11 and continues the game process.

In the case that the game processing part 36 judged that the character entered the virtual store (YES at S12), the selling processing part 31 of the processing part 10 starts the digital content purchasing process. On the basis of the information stored in the secondary storage part 16 or the recording medium 9, the selling processing part 31 displays, for example, the list of purchasable digital contents or the detailed information of the digital content selected by the user (at step S14). The selling processing part 31 judges whether the operation for leaving the virtual store was performed (at step S15). In the case that the operation for leaving the virtual store was performed (YES at S15), the processing part 10 returns the process to step S11, and the game processing part 36 performs the game process. In the case that the operation for leaving the virtual store was not performed (NO at S15), the selling processing part 31 judges whether the operation for a digital content estimation request was performed (at step S16). In the case that the operation for the estimation request is not performed (NO at S16), the selling processing part 31 returns the process to step S14 and continues the display of the list of digital contents or the detailed information thereof, for example.

In the case that the operation for the estimation request was performed (YES at S16), the selling processing part 31 transmits the estimation request to the server apparatus 5 via the communication part 14 (at step S17). In the case that it was judged at step S9 that the purchasing process was interrupted at the estimation stage or in the case that it was judged at step S10 that the purchasing process was interrupted at the settlement stage, the restart processing part 35 of the processing part 10 makes the selling processing part 31 to restart the process from the transmission of the estimation request at step S17. Then, the selling processing part 31 judges whether an estimate was received from the server apparatus 5, for example, within a predetermined time (at step S18). In the case that no estimate is received from the server apparatus 5 (NO at S18), the interruption processing part 32 of the processing part 10 stores the interruption information 16a including information indicating that the interrupted stage is the estimation stage in the secondary storage part 16 (at step S19). The interruption processing part 32 gives an instruction to the display processing part 37, thereby making the display part 11 to display the interruption notification screen 80 (at step S20). The processing part 10 returns the process to step S14, and the selling processing part 31 continues the display of the list of digital contents or the detailed information thereof, for example.

In the case that the estimate was received from the server apparatus 5 (YES at S18), the selling processing part 31 judges whether the purchase request operation for the estimated digital content was performed (at step S21). In the case that the purchase request operation is not performed (NO at S21), the selling processing part 31 returns the process to step S14 and continues the display of the list of digital contents or the detailed information thereof, for example. In the case that the purchase request operation was performed (YES at S21), the selling processing part 31 transmits the digital content purchase request to the server apparatus 5 via the communication part 14 (at step S22).

The selling processing part 31 judges whether the predetermined settlement process was started by the server apparatus 5 (at step S23). In the case that the settlement process was started (YES at S23), the selling processing part 31 performs the transmission/reception of necessary information between the game machine 1 and the server apparatus 5 and then performs the settlement process (at step S24). The selling processing part 31 judges whether the settlement process was ended normally without causing an abnormal end or the like (at step S25). In the case that the settlement process is not started (NO at S23) or the settlement process is not ended normally (NO at S25), the interruption processing part 32 of the processing part 10 stores the interruption information 16a including information indicating that the interruption stage is the settlement stage in the secondary storage part 16 (at step S26). The interruption processing part 32 makes the display processing part 37 to display the interruption notification screen 80 on the display part 11 (at step S27). The processing part 10 returns the process to step S14, and the selling processing part 31 continues the display of the list of digital contents or the detailed information thereof, for example.

In the case that the settlement process was ended normally (YES at S25), the selling processing part 31 gives the transmission request for the digital content having been subjected to the settlement process to the server apparatus 5 via the communication part 14 (at step S28). The selling processing part 31 judges whether the reception of the digital content transmitted from the server apparatus 5 in response to the transmission request was completed (at step S29). In the case that the reception of the digital content was unable to be completed, for example, because the reception of the digital content was interrupted (NO at S29), the interruption processing part 32 stores the interruption information 16a including information indicating that the interruption stage is the downloading stage in the secondary storage part 16 (at step S30). The interruption processing part 32 makes the display processing part 37 to display the interruption notification screen 80 on the display part 11 (at step S31). The processing part 10 returns the process to step S14, and the selling processing part 31 continues the display of the list of digital contents or the detailed information thereof, for example. In the case that the reception of the digital content was completed (YES at S29), the selling processing part 31 returns the process to step S14 and continues the display of the list of digital contents or the detailed information thereof, for example. The display of the list of digital contents or the detailed information thereof, for example, continues until the operation for leaving the virtual store is performed.

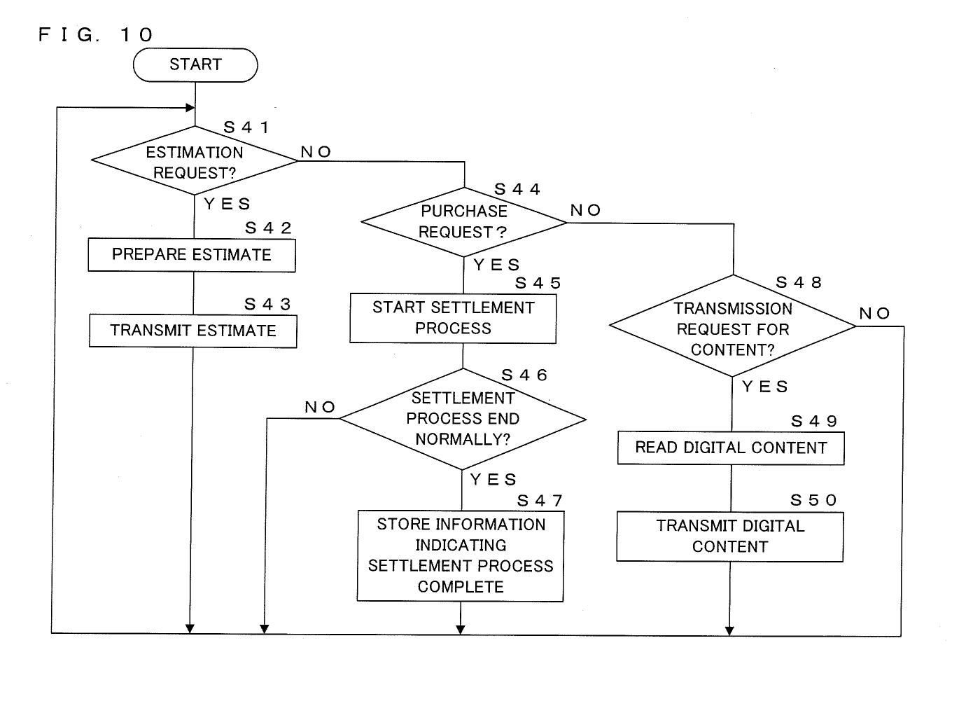

FIG. 10 is a flow chart showing the steps of process performed by the server apparatus 5. The selling processing part 61 of the server apparatus 5 judges whether the estimation request from the game machine 1 was received via the communication part 14 (at step S41). In the case that the estimation request was received (YES at S41), the selling processing part 61 checks the price of the digital content relating to the estimation request and prepares an estimate including this price information (at step S42). The selling processing part 61 transmits the prepared estimate to the game machine 1 serving as the transmission origin of the estimation request via the communication part 53 (at step S43) and returns the process to step S41.

In the case that the estimation request is not received (NO at S41), the selling processing part 61 judges whether a purchase request was received from the game machine 1 via the communication part 53 (at step S44). In the case that the purchase request was received (YES at S44), the selling processing part 61 starts the predetermined settlement process with the game machine 1 serving as the transmission origin of the purchase request (at step S45). Then, the selling processing part 61 judges whether the settlement process was ended normally without causing an abnormal end or the like (at step S46). In the case that the settlement process was ended normally (YES at S46), the selling processing part 61 stores information indicating that the settlement of the digital content to be processed was completed in the storage part 54 (at step S47) and returns the process to step S41. In the case that the settlement process was not ended normally (NO at S46), the selling processing part 61 returns the process to step S41.

In the case that the purchase request is not received (NO at S44), the selling processing part 61 judges whether the transmission request for the digital content having been subjected to the settlement process was received from the game machine 1 via the communication part 53 (at step S48). In the case that the transmission request for the digital content was received (YES at S48), the selling processing part 61 reads the digital content relating to the transmission request from the storage part 54 (at step S49). The selling processing part 61 transmits the read digital content to the game machine 1 serving as the transmission origin of the transmission request (at step S50) and returns the process to step S41. In the case that the transmission request for the digital content is not received (NO at S48), the selling processing part 61 returns the process to step S41 and stands by until the request from the game machine 1 is received.

In the product selling system having the above-mentioned configuration, the game machine 1 and the server apparatus 5 perform communication, thereby performing the product selling process to sell and purchase digital contents. In the case that the interruption of the selling process was detected by the selling processing part 31 of the game machine 1, the interruption processing part 32 stores the interruption information 16a in the secondary storage part 16. Then, the restart judging part 33 of the game machine 1 judges whether the interrupted process can be restarted at a predetermined timing. In the case that the restart judging part 33 judged that the interrupted process can be restarted, the restart processing part 35 of the game machine 1 restarts the process from a predetermined point in the processing stage of the selling process of the selling processing part 31. Hence, the user of the game machine 1 is not required to restart the interrupted procedure for purchasing the digital content from the beginning. This prevents the user from forgetting to attempt to purchase the digital content and prevents, for example, digital content vending companies from losing sales opportunities.

In the case that the restart judging part 33 of the game machine 1 judged that the restart is possible, the restart selection accepting part 34 accepts the selection as to whether the interrupted process is restarted. At this time, the restart selection accepting part 34 makes the display processing part 37 to display the selection accepting screen 81 on the display part 11. As a result, the user himself of the game machine 1 can make the selection as to whether the interrupted process is restarted. The icon 81a indicating the digital content the user was attempting to purchase is displayed on the selection accepting screen 81. Consequently, the user can easily judge whether the procedure for purchasing the digital content the user was attempting to purchase is restarted.

In the case that the “CANCEL” button 81d or the “LATER” button 81e was operated on the selection accepting screen 81 of the game machine 1 and that the restart selection accepting part 34 accepted the selection of not restarting the interrupted process, the restart processing part 35 does not restart the interrupted process. In the case that the “LATER” button 81e was operated, the restart selection accepting part 34 accepts again the selection as to whether the interrupted process is restarted at a predetermined timing thereafter. Hence, even in the case that the user does not desire to restart the process at the time when the selection accepting screen 81 was displayed on the display part 11, the process can be restarted at a time further thereafter.

In the case that the interruption processing part 32 of the game machine 1 detected the interruption of the communication with the server apparatus 5, the interruption processing part 32 judges that the process relating to the product selling by the selling processing part 31 was interrupted. The restart judging part 33 judges whether the communication with the server apparatus 5 can be made at a predetermined timing, thereby judges whether the interrupted process can be restarted. Hence, the game machine 1 can restart the product selling process that was interrupted because of a communication problem between the game machine 1 and the server apparatus.

The restart selection accepting part 34 of the game machine 1 judges whether the interrupted process can be restarted at a predetermined timing after the process performed by the selling processing part 31 was interrupted. For example, the timing when the judgment is made can be set to the time when the processing part 10 read and executed the game program 91 and started the process. For example, the timing when the judgment is made can be set to the start time of the game machine 1. The interrupted process can be restarted without disturbing the game played by the user by making the judgment at the timing.

The game machine 1 stores, for example, the product information of purchasable digital contents in the secondary storage part 16 or the recording medium 9 together with the game program 91. The game machine 1 is configured so as to be able to display the list of digital contents or the detailed information thereof in the off-line state. With this configuration, the selling processing part 31 of the game machine 1 obtains the price information of a digital content from the server apparatus 5 as an estimate, thereby capable of responding to the change in the price of the digital content.

The process performed by the selling processing part 31 of the game machine 1 includes, for example, the estimate obtaining process, the settlement process and the digital content downloading process, these processes requiring communication with the server apparatus 5. The process performed by the selling processing part 31 further includes, for example, the process of displaying the list of digital contents and the detailed information thereof and the process of accepting the selection of a digital content to be purchased from the displayed digital contents, these processes not requiring communication with the server apparatus 5. The selling processing part 31 performs processes requiring communication after the processes not requiring communication. In other words, the selling processing part 31 first performs processes not requiring communication and then performs processes requiring communication. Even in the case that a process requiring communication was interrupted, the selling processing part 31 can perform a process not requiring communication. Hence, even in the case that the game machine 1 cannot make communication with the server apparatus 5, the user can perform part of the procedure relating to the purchase of the digital content using the game machine 1.

The selling processing part 31 of the game machine 1 performs the process in three stages: the digital content estimation stage, the settlement stage and the downloading stage. In the case that the process was interrupted at the estimation stage or the settlement stage, the restart processing part 35 restarts the process from the estimation stage. In the case that the process was interrupted at the downloading stage, the restart processing part 35 restarts the process from the downloading stage. Since the process is restarted from the estimation stage even in the case that the process was interrupted at the settlement stage, the game machine 1 can respond to the change in the price of the digital content in the period between the interruption and the restart. In the case that the interruption processing part 32 detected the interruption of the process, the interruption processing part 32 stores the interruption information 16a including information on at which stage the process was interrupted in the secondary storage part 16. Hence, the restart processing part 35 can restart the process from an appropriate stage on the basis of the stored interruption information 16a.

The game machine 1 can perform the game process using the game processing part 36 by executing the game program 91 in the processing part 10 in addition to the process relating to product selling. For example, in the case that a predetermined condition that the character of the user entered the virtual store is satisfied in the game of the game processing part 36, the game machine 1 performs the process relating to the selling and purchase of digital contents using the selling processing part 31. The selling processing part 31 performs the process relating to the selling and purchase of digital contents, such as items used in games, additional scenarios or additional stages of games, or mini games that can be played inside the games. The game process using the game processing part 36 can be performed even in the case that the communication with the server apparatus 5 relating to the selling and purchase of digital contents is impossible.

Although a communication problem was taken as an interruption factor of the process performed by the selling processing part 31 of the game machine 1 in the embodiment, the interruption factor is not limited to this. As an interruption factor of the selling process, for example, a case can be conceived in which the selling process cannot be performed because of the maintenance of the server apparatus 5 even if the communication between the game machine 1 and the server apparatus 5 is possible. As another interruption factor, for example, the interruption of the selling process because of the setting or trouble in the game machine 1 can also be conceived.

Although the configuration in which digital contents are sold and purchased between the game machine 1 and the server apparatus 5 is used in the embodiment, the configuration is not limited to this configuration. It may be possible to use a configuration in which actual products, instead of digital contents, are sold and purchased between the game machine 1 and the server apparatus 5. In this case, the downloading stage of the process is not performed. In the case of a configuration in which the server apparatus 5 manages the list (the so-called favorite list) of products to be considered of purchasing by the user, a configuration may also be used in which the interruption of a process, such as the addition or deletion of product items to or from the list, may be restarted.

The steps of the process, the steps of the procedure or the stages of selling in the game machine 1 and the server apparatus 5 described in the embodiment, for example, are merely examples and not limited to these examples. For example, in the selling process, a configuration may be used in which the game machine 1 does not obtain the estimate of a digital content from the server apparatus 5. For example, a configuration may also be used in which the game machine 1 obtains the price information of purchasable digital contents collectively from the server apparatus 5, for example, in the case that a game was started or the character of the user entered the virtual store in the game. Furthermore, a configuration may also be used in which, for example, the price information of digital contents is transmitted from the server apparatus 5 to the game machine 1 at the settlement stage.

In the embodiment, the case in which, for example, the estimation and purchase are performed for a single digital content has been described. However, for example, a plurality of digital contents can be estimated or purchased collectively. The content of the game performed by the game processing part 36 in the description of the embodiment is merely an example, and the content is not limited to this. A similar configuration may be applied to various games that can be performed by the game processing part 36.

The interruption notification screen 80 shown in FIG. 5 and the selection accepting screen 81 shown in FIG. 6 are merely examples and not limited to these. For example, on the interruption notification screen 80, it may be possible to inquire the user whether he desires to restart the interrupted process from halfway. For example, on the selection accepting screen 81, a configuration may also be used in which the restart selection accepting part 34 accepts the selection between whether or not the interrupted process is restarted, instead of providing the “LATER” button 81e.

Although the configuration in which the process is restarted from the estimation stage even in the case that the process was interrupted at the settlement stage is used in the embodiment, the configuration is not limited to this. For example, in the case that the price of a product does not change or, for example, in the case that a term of validity is set in the estimate and the present time is within the term of validity, a configuration may also be used in which the process interrupted at the settlement stage can be restarted from the settlement stage.

In the game machine 1, while an interrupted process is not restarted, another process may be interrupted; in other words, a plurality of processes may be interrupted continuously. In this case, the restart processing part 35 of the game machine 1 may restart the processes from the last interrupted process. Furthermore, for example, the restart processing part 35 may accept, from the user, the selection of a process to be restarted from among the plurality of interrupted processes and may restart the selected process.

Although the portable-type game machine 1 has been described as an example in the embodiment, the apparatus according to the embodiment is not limited to this. For example, a similar technology is applicable to various information processing apparatuses, such as stationary-type game machines, general-purpose computers, tablet-type terminals or portable telephones. The apparatus configurations of the product selling system and the function allocation in the respective apparatuses are not limited to those described in the embodiment. For example, the server apparatus 5 may have at least part of the functions described as the functions of the game machine 1. Conversely, the game machine 1 may have at least part of the functions described as the functions of the server apparatus 5. The functions of the server apparatus 5 may not be realized using one server apparatus but may be realized using a plurality of server apparatuses.

(Modification)

In a product selling system according to a modification, the process relating to, for example, the interruption and restart of the selling process is not performed by the game machine 1 but by the server apparatus 5. In the server apparatus 5 according to the modification, in the case that the selling process between the server apparatus 5 and the game machine 1 using the selling processing part 61 was interrupted, for example, because of communication disability, information, such as the stage of the interrupted process and the product to be purchased, is stored in the storage part 54 as interruption information. Then, the server apparatus 5 inquires the game machine 1 whether the interrupted process is restarted, at a predetermined timing, for example, at the time when the communication with the game machine 1 has become possible. In response to this inquiry, the selection by the user is accepted at the game machine 1 and the selection is transmitted from the game machine 1 to the server apparatus 5. In the case that the selection of the restart of the process was accepted at the game machine 1, the server apparatus 5 restarts the process, for example, from the stage of the preparation of the estimate of a product and transmits the prepared estimate to the game machine 1. The restart of the process at the server apparatus 5 may be performed from a stage other than the estimate preparation stage, for example, the settlement stage or the digital content transmission stage.

### Embodiment 2

In a product selling system according to Embodiment 2, electronic books are sold and purchased between an electronic book reader and a server apparatus. The electronic book reader displays letters, characters, images, etc. relating to electronic books stored in its internal memory or the like on its display part and switches the page to be displayed depending on the operation of the user. The electronic book reader has a function of making wireless communication with the server apparatus. The electronic book reader can purchase electronic books sold by the server apparatus and can download the electronic books into the internal memory or the like. The user can access the server apparatus from the electronic book reader and can, for example, display the list of purchasable electronic books and retrieve electronic books by inputting keywords. Hence, the user selects an electronic book to be purchased and gives the purchase request for the electronic book to the server apparatus. As in the case of the product selling system according to the above-mentioned embodiment, a configuration may also be used in which the estimation request for the electronic book from the electronic book reader and the transmission of the estimate thereof from the server apparatus are performed before the purchase request for the electronic book is sent.

In Embodiment 2, an electronic book to be sold by the server apparatus is provided with guide information about other electronic books on the last page, for example. The guide information can be provided, for example, as a guide for the succeeding volumes of the electronic book or a guide for other books of the same author. The electronic book reader can display, for example, on the last page of an electronic book, guide information about other electronic books, and can accept the selection of the displayed other electronic books as electronic books to be purchased. In the case that an electronic book was selected as the electronic book to be purchased according to the guide information, the electronic book reader gives the purchase request for the electronic book to the server apparatus.

In response to the purchase request from the electronic book reader, the server apparatus starts a settlement process between the server apparatus and the electronic book reader. In the settlement process, for example, information, such as a credit card number and a password, is transmitted and received between the electronic book reader and the server apparatus. In the case that the settlement process was ended normally, the server apparatus transmits the data of the electronic book to the electronic book reader. The electronic book reader receives the data of the electronic book transmitted from the server apparatus and stores the data in the internal memory or the like.

For example, in the case that communication was unable to be established when the purchase request for an electronic book was transmitted from the electronic book reader to the server apparatus, the process for purchasing the electronic book by the electronic book reader is interrupted. At this time, the electronic book reader displays an error message or the like and interrupts the purchasing process. The electronic book reader stores information relating to the interrupted process in the memory part. Then, the user can browse the electronic books stored in the internal memory or the like using the electronic book reader, regardless of whether the communication with the server apparatus is possible.

After the purchasing process of the electronic book was interrupted, the electronic book reader judges whether communication with the server apparatus is possible and judges whether the interrupted purchasing process can be restarted at a predetermined timing, for example, when the user turned on the power source of the electronic book reader. In the case that the electronic book reader judged that the communication with the server apparatus is possible and that the purchasing process can be restarted, the electronic book reader displays a message or the like on the display part and accepts the selection of whether the interrupted process for purchasing the electronic book is restarted.

In the case that the electronic book reader accepted the selection of not restarting the interrupted process, the electronic book reader does not restart the interrupted process. In the case that the electronic book reader accepted the selection of restarting the interrupted process, the electronic book reader reads the information relating to the interrupted process and restarts the interrupted process. For example, in the case that the process was interrupted because the communication with the server apparatus was impossible when the purchase request for the electronic book is transmitted, the electronic book reader restarts the process from the stage of transmitting the purchase request for the electronic book. For example, in the case that the process was interrupted in the middle of the settlement process between the electronic book reader and the server apparatus, the electronic book reader may restart the process from the time when the settlement process was interrupted or may restart the process from the start time of the settlement process.

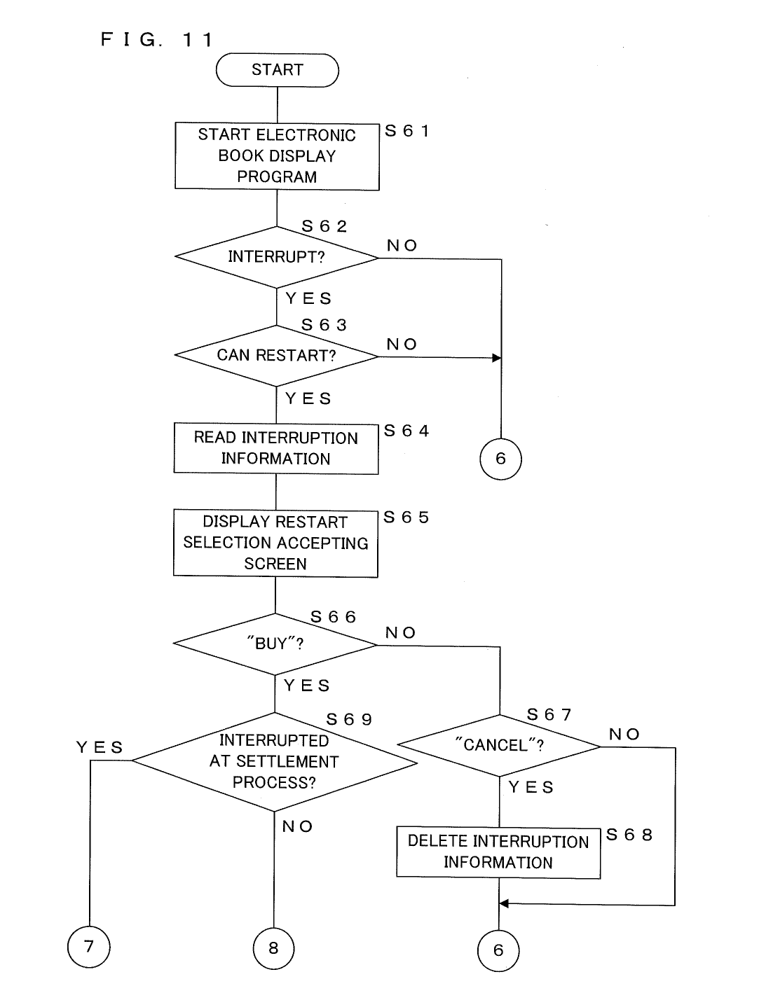

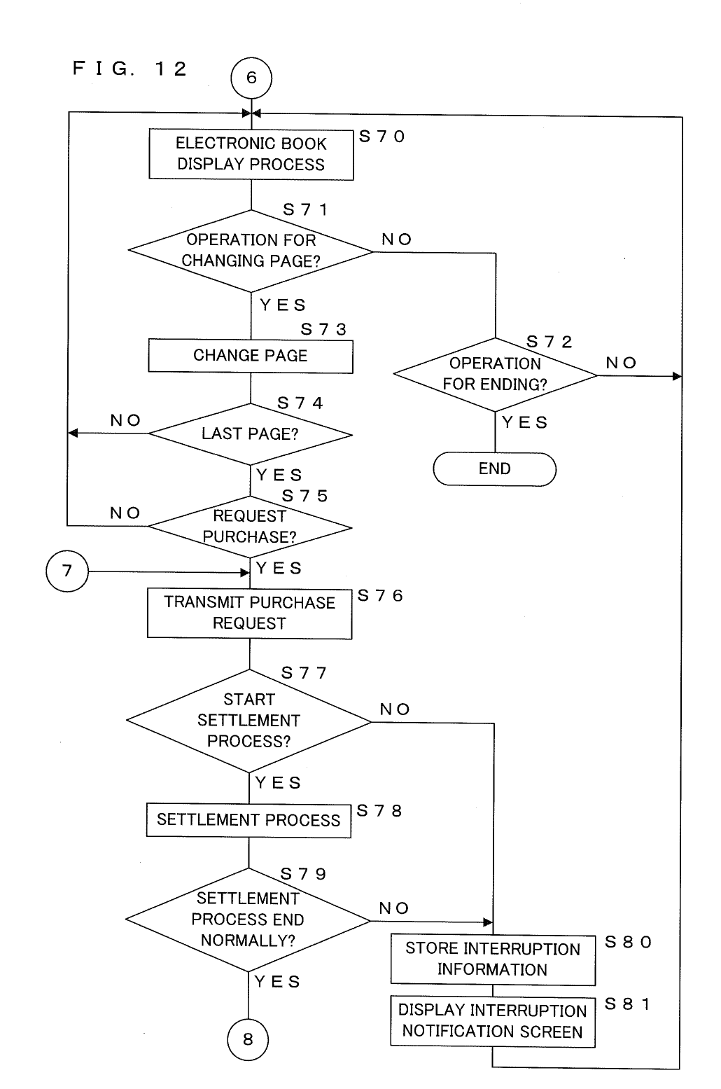

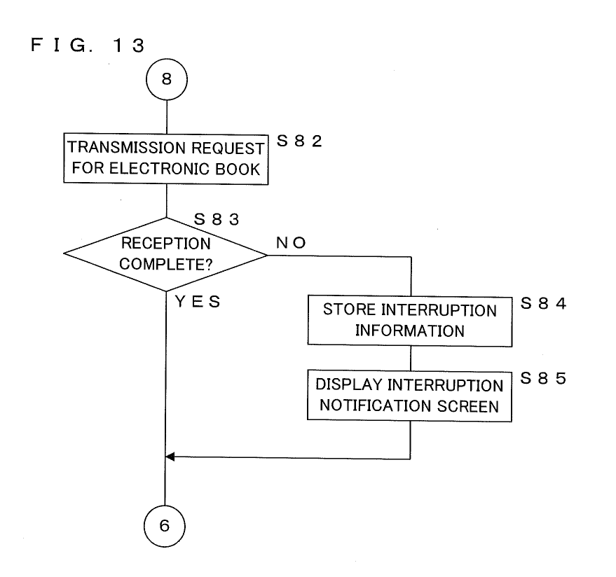

FIGS. 11 to 13 are flow charts showing the steps of the process performed by the electronic book reader according to Embodiment 2. The flow charts show a case in which the user makes a purchase request for an electronic book included in the guide information displayed on the last page of another electronic book. In the flow charts, a case in which the user directly accesses the server apparatus using the electronic book reader to purchase an electronic book is not shown. In the flow charts, it is assumed that the judgment as to whether the electronic book purchasing process is restarted is made at the process start time of an electronic book display program. In the flow charts, the purchasing process is divided into a settlement stage and a downloading stage, and it is assumed that the process is restarted from the settlement stage or the downloading stage depending on the stage at which the process was interrupted.

The electronic book reader reads and executes the electronic book display program stored in an internal ROM or the like, thereby starting an electronic book display process (at step S61). At this time, the electronic book reader checks, for example, whether interruption information has been stored in the internal memory or the like. With this checking, the electronic book reader judges whether the electronic book purchasing process was interrupted before (at step S62). In the case that it was judged that the purchasing process was interrupted (YES at S62), the electronic book reader attempts to communicate with the server apparatus. Depending on the presence/absence of the response from the server apparatus, the electronic book reader judges whether the purchasing process can be restarted (at step S63). In the case that the purchasing process is not interrupted (NO at S62) or the purchasing process cannot be restarted (NO at S63), the electronic book reader advances the process to step S70.

In the case that it was judged that the purchasing process can be restarted (YES at S63), the electronic book reader reads the interruption information stored in the internal memory or the like (at step S64). The electronic book reader displays a restart selection accepting screen on the display part (at step S65). The electronic book reader accepts the selection of “BUY”, “CANCEL” or “LATER” on the restart selection accepting screen. The electronic book reader judges whether “BUY” was selected (at step S66). In the case that “BUY” is not selected (NO at step S66), the electronic book reader judges whether “CANCEL” was selected (at step S67). In the case that “CANCEL” was selected (YES at S67), the electronic book reader deletes the interruption information stored in the memory or the like (at step S68) and advances the process to step S70. In the case that “CANCEL” is not selected (NO at S67), that is, in the case that “LATER” was selected, the electronic book reader advances the process to step S70.

In the case that it was judged that “BUY” was selected on the restart selection accepting screen (YES at S66), the electronic book reader judges to determine at which stage the previous purchasing process was interrupted on the basis of the interruption information stored in the memory or the like. The electronic book reader judges whether the purchasing process was interrupted at the settlement process (at step S69). In the case that the purchasing process was interrupted at the settlement stage (YES at S69), the electronic book reader advances the process to step S76 and restart the process from the transmission of the purchase request. In the case that the purchasing process is not interrupted at the settlement stage (NO at S69), that is, in the case that the purchasing process was interrupted at the downloading stage, the electronic book reader advances the process to step S28 and restarts the process from the transmission request for the electronic book.

In the case that the previous purchasing process is not interrupted or, for example, in the case that the user does not desire to restart the interrupted process, the electronic book reader performs the electronic book display process (at step S70). The electronic book reader judges whether an operation for changing the page of an electronic book was accepted through the operation part or the like (at step S71). In the case that the page changing operation is not accepted (NO at S71), the electronic book reader judges whether an operation for ending the electronic book display process was performed (at step S72). In the case that the ending operation was performed (YES at step S72), the electronic book reader ends the electronic book display process. In the case that the ending operation is not performed (NO at S72), the electronic book reader returns the process to step S70 and continues the electronic book display process.

In the case that the operation for changing the page of the electronic book was accepted (YES at S71), the electronic book reader changes the page of the electronic book to be displayed (at step S73). The electronic book reader judges whether the page displayed after the page change is the last page (at step S74). In the case that the page is the last page (YES at S74), the electronic book reader judges whether the operation for the purchase request based on the guide information displayed on the last page was performed (at step S75). In the case that the page after the page change is not the last page (NO at S75) or in the case that the operation for the purchase request based on the guide information displayed on the last page was not performed, the electronic book reader returns the process to step S70 and continues the electronic book display process.

In the case that the operation for the purchase request was performed (YES at S75), the electronic book reader transmits the purchase request for an electronic book to the server apparatus (at step S76). The electronic book reader judges whether the predetermined settlement process was started by the server apparatus 5 (at step S77). In the case that the settlement process was started (YES at S77), the electronic book reader performs the transmission/reception of necessary information between the electronic book reader and the server apparatus and then performs the settlement process (at step S78). The electronic book reader judges whether the settlement process was ended normally (at step S79). In the case that the settlement process is not started (NO at S77) or the settlement process is not ended normally (NO at S79), the electronic book reader stores interruption information including the information indicating that the interruption stage is the settlement stage in the memory or the like (at step S80). The electronic book reader displays an interruption notification screen on the display part (at step S81), returns the process to step S70 and continues the electronic book display process.

In the case that the settlement process was ended normally (YES at S79), the electronic book reader gives the transmission request for the electronic book having been subjected to the settlement process to the server apparatus (at step S82). The electronic book reader judges whether the reception of the electronic book transmitted from the server apparatus in response to the transmission request was completed (at step S83). In the case that the reception of the electronic book was unable to be completed, for example, because the reception of the electronic book was interrupted (NO at S83), the electronic book reader stores interruption information including the information indicating that the interruption stage is the downloading stage in the memory or the like (at step S84). The electronic book reader displays the interruption notification screen on the display part (at step S85), returns the process to step S70 and continues the electronic book display process. In the case that the reception of the digital content was completed (YES at S83), the electronic book reader returns the process to step S70 and continues the electronic book display process. The electronic book display process continues until the operation for ending the process is performed.

In the product selling system having the above-mentioned configuration according to Embodiment 2, the electronic book reader and the server apparatus perform communication, thereby performing the product selling process to sell and purchase electronic books. In the case that the interruption of the process was detected, the electronic book reader stores the interruption information. Then, the electronic book reader judges whether the interrupted process can be restarted at a predetermined timing. In the case that it was judged that the restart is possible, the electronic book reader restarts the process from a predetermined point in the processing stage of the selling process. Hence, the user of the electronic book reader is not required to restart the interrupted procedure for purchasing the electronic book from the beginning. This prevents the user from forgetting to attempt to purchase the electronic book and prevents, for example, electronic book vending companies from losing sales opportunities.

In Embodiment 2, the configurations of the electronic book reader and the server apparatus are not shown. The configurations of the electronic book reader and the server apparatus according to Embodiment 2 are similar to those of the game machine 1 shown in FIG. 3 and the server apparatus 5 shown in FIG. 4, respectively. The electronic book reader according to Embodiment 2 has function blocks similar to the selling processing part 31, the interruption processing part 32, the restart judging part 33, the restart selection accepting part 34 and the restart processing part 35 of the game machine 1, and these function blocks may be realized by hardware or software.

Although the electronic book reader has been described as an example in Embodiment 2, the apparatus according to the embodiment is not limited to this. For example, a technology similar to that described in Embodiment 2 is applicable to various information processing apparatuses, such as general-purpose computers, tablet-type terminals or portable telephones. A technology similar to that described above is applicable to application programs for browsing electronic books to be executed by these information processing apparatuses. For example, the digital contents to be sold and purchased between the game machine 1 and the server apparatus 5 may be electronic books.

A configuration similar to that described above is also applicable to an information processing apparatus for performing processes, such as the display and purchase of moving images. For example, the information processing apparatus can be configured so as to reproduce a moving image and to display guide information at the end of the image, The information processing apparatus accepts the operation for requesting the purchase of a moving image on the basis of the guide information, performs a settlement process with the server apparatus and downloads the moving image relating to the purchase request. The moving image may be distributed by streaming transmission. In the case that the process relating to the purchase of the moving image was interrupted at the settlement stage or the downloading stage, the information processing apparatus judges whether the interrupted process can be restarted at a predetermined timing thereafter. In the case that it was judged that the process can be restarted, the information processing apparatus restarts the process from the interrupted stage.

In the case that components are used in the present description, each component expressed in a singular form with “a” or “an” placed in front thereof is construed not to exclude components expressed in a plural form.

In the product selling system according to the embodiment, the user is not required to perform the interrupted procedure for purchasing a product from the beginning. The interrupted process is restarted in the product selling system, whereby it is possible to prevent the user from forgetting to attempt to purchase a product and to prevent, for example, stores from losing sales opportunities.

What is claimed is:

1. A non-transitory recording medium recording an information processing program, making an information processing apparatus equipped with a communication part for making communication via a network operate as:
a selling processing part for performing a process for selling product,
a restart judging part for judging whether, after a process using the communication part and being included in the process performed by the selling processing part is interrupted, the interrupted process can be restarted or not, and
a restarting part for restarting the process performed by the selling processing part from an interrupted point in the process in the case where the restart judging part judged that the process can be restarted.

2. The recording medium according to claim 1, wherein the process performed by the selling processing part includes a first process requiring communication using the communication part and a second process not requiring communication using the communication part.

3. The recording medium according to claim 2, wherein the selling processing part performs the first process subsequent to the second process.

4. The recording medium according to claim 2, wherein the selling processing part can perform the second process even in the case that the first process is interrupted.

5. The recording medium according to claim 4, wherein the selling processing part performs the second process at the start time of the process for selling product.

6. The recording medium according to claim 2, wherein the first process includes a process for obtaining the price information of the product from another apparatus by communication using the communication part.

7. The recording medium according to claim 2, wherein the second process includes a process of indicating the information of the product.

8. The recording medium according to claim 1, making the information processing apparatus operate as:
an accepting part for accepting a selection as to whether the process performed by the selling processing part is restarted in the case that the restart judging part judged that the process can be restarted,
wherein the restarting part restarts the process performed by the selling processing part in the case that the accepting part accepted the selection of restarting the process.

9. The recording medium according to claim 8, making the information processing apparatus operate as:
a display processing part for displaying, on a display part, a selection accepting screen through which the selection by the accepting part is accepted,
wherein the accepting part accepts the selection as to whether the process performed by the selling processing part is restarted depending on the operation performed on the selection accepting screen.

10. The recording medium according to claim 8, wherein
the restarting part does not restart the process performed by the selling processing part in the case that the accepting part accepted the selection of not restarting the process, and
the accepting part accepts the selection as to whether the process performed by the selling processing part is restarted at a time after the selection of not restarting the process is accepted.

11. The recording medium according to claim 1, wherein after the communication with another apparatus using the communication part is interrupted, the restart judging part judges whether the communication with said another apparatus using the communication part is possible or not.

12. The recording medium according to claim 1, wherein the restart judging part judges whether the interrupted process can be restarted at the start time of the information processing apparatus.

13. The recording medium according to claim 1, wherein the restart judging part judges whether the interrupted process can be restarted at the start time of the information processing program.

14. The recording medium according to claim 1, wherein the selling processing part performs a process of obtaining the price information of the product from another apparatus by communication using the communication part.

15. The recording medium according to claim 1, wherein
the selling processing part performs the process for selling the product in stages, whereby
in the case that a process performed using communication via the communication part is interrupted, the information processing apparatus is operated as a storage processing part for storing a processing stage, and
the restarting part restarts the process performed by the selling processing part from the stage stored in the storage processing part.

16. The recording medium according to claim 1, wherein
the information processing apparatus is operated as an information processing part for performing information processing different from the process performed by the selling processing part, and
in the case that a predetermined condition is satisfied by the information processing of the information processing part, the selling process by the selling processing part is performed.

17. The recording medium according to claim 16, wherein
the information processing part performs information processing relating to a game, and
the selling processing part performs a process relating to the selling and purchase of a content in the game.

18. The recording medium according to claim 16, wherein
the information processing part can perform the information processing regardless of whether the communication using the communication part is possible or not.

19. An information processing apparatus equipped with a processor and a communication circuit for making communication via a network, the processor performing the processing of:
selling product;
judging, after a process using the communication circuit, included in the selling process, is interrupted, whether the interrupted process can be restarted or not; and
restarting the selling process from a predetermined point in the selling process in the case where it is judged that the interrupted process can be restarted.

20. A product selling system comprising:
an information processing apparatus having
a communication part for making communication via a network,
a selling processing part for performing a process for selling product,
a restart judging part for judging whether, after a process using the communication part and being included in the process performed by the selling processing part is interrupted, the interrupted process can be restarted or not, and
a restarting part for restarting the process performed by the selling processing part from a predetermined point in the processing stage of the process in the case that the restart judging part judges that the process can be restarted; and
a server apparatus having a communication part for making communication with the information processing apparatus via a network and a selling processing part for performing a process for selling product between the information processing apparatus and the server apparatus by using communication via the communication part.

21. A product selling method comprising the steps of:
after a process using communication via a network and included in the selling process is interrupted, judging whether the interrupted process can be restarted or not, and
in the case that it is judged that the interrupted process can be restarted, restarting the selling process from a predetermined point in the processing stage of the selling process.
